(19) United States
(12) Patent Application Publication
(10) Pub. No.: US 2015/0230010 A1
(43) Pub. Date: Aug. 13, 2015

(54) TRANSDUCER APPARATUS COMPRISING TWO MEMBRANES

(71) Applicants: Mikko Veli Aimo Suvanto, Pittsburg, PA (US); Risto Antero Kaivola, Tampere (FI)

(72) Inventors: Mikko Veli Aimo Suvanto, Pittsburg, PA (US); Risto Antero Kaivola, Tampere (FI)

(73) Assignee: Nokia Corporation, Espoo (FI)

(21) Appl. No.: 14/236,864

(22) PCT Filed: Aug. 5, 2011
(86) PCT No.: PCT/IB2011/053507

§ 371 Date: May 2, 2014

(51) Int. Cl. H04R 1/00

(52) U.S. Cl. CPC H04R 1/00

(57) ABSTRACT

An acoustic transducer comprising: at least two membranes; and at least one adjustable coupling configured to adjustably couple oscillations between a first membrane and a second membrane of the at least two membranes.

### FIELD OF THE APPLICATION

The present invention relates to a transducer apparatus. The invention further relates to, but is not limited to, a transducer apparatus for use in mobile devices.

### BACKGROUND OF THE APPLICATION

Many portable devices, for example mobile telephones, contain a number of acoustic transducers, such as microphones, earpieces and speakers. Such transducers are key components in mobile phone audio/acoustic design. Generally, there will be one or more sound channels or back cavities associated with each acoustic transducer. Such sound channels can ensure a certain frequency response is obtained for the transducer, and must be carefully designed as part of the mechanical configuration of the device hardware. Small changes in the size and configuration of the sound channels or cavities can have a large effect on the acoustic properties of the combined transducer/sound channel.

In known acoustic transducer configurations, the mechanical design of the sound channels is fixed at the point of hardware design and manufacture of the device is completed, and cannot be later adapted during use for a specific purpose or desired configuration. Instead, the desired acoustic properties are produced by filtering the electrical signal representing the sound output before the signal is applied to the transducer. Typically, this requires the use of significant processing power, commonly provided by dedicated digital signal processors (DSPs).

Furthermore there is a limit to the modification of the acoustic response of the transducer which can be carried out in the DSP.

An example of the limitations of the mechanical design of typical microphone transducers is that of wind noise. Wind noise is a problem particularly for miniaturised designs such as found in mobile phone where there is no room for mechanical protection of the microphone from wind such as used in broadcast microphones like wind screens or foam protectors. Furthermore filtering out the wind noise from the signal in the electrical domain requires significant processing power in a digital signal processor, typically produces poor results as the sound pressure levels generated by the wind cause the microphone acoustic element to saturate, and also filters wanted signals where the filter is set to a wide frequency range.

### STATEMENT OF THE APPLICATION

It is an aim of at least some embodiments of the invention to address one or more of these problems.

According to a first aspect there is provided an acoustic transducer comprising: at least two membranes; and at least one adjustable coupling configured to adjustably couple oscillations between a first membrane and a second membrane of the at least two membranes.

The at least one adjustable coupling may comprise at least one of: at least one adjustable mechanical coupling; at least one adjustable hydraulic coupling; and at least one adjustable pneumatic coupling.

The acoustic transducer may further comprise a controller configured to determine at least one characteristic of the oscillation from the first membrane and control the at least one adjustable coupling dependent on the characteristic.

The characteristic of the oscillation may comprise at least one of: maximum amplitude of the oscillation; energy of the oscillation; and frequency distribution of the oscillation.

The adjustable coupling may be configured to decouple oscillations between a first membrane and a second membrane of the at least two membranes.

The second membrane may be configured to directly receive a sound pressure wave from the exterior of the acoustic transducer.

The at least one adjustable coupling may comprise: a volume of air between the first membrane and the second membrane; and an adjustable valve configured to seal, partially seal or open the volume of air.

The acoustic transducer may further comprise an acoustic transducer support structure configured to locate the first and the second membrane and define the volume of air between the first membrane and the second membrane, wherein the adjustable valve is defined by the acoustic transducer support structure and one of the first and second membranes.

The at least one adjustable coupling may comprise: a volume of liquid between the first membrane and the second membrane; and an adjustable valve configured to seal, partially seal or open the volume of liquid.

The at least one adjustable coupling may comprise at least one rotational coupling rod configured to selectively rotate to a first position to physically couple the first membrane to the second membrane, and to a second position to physically decouple the first membrane to the second membrane.

The at least one adjustable coupling may comprise at least one scissor coupling member.

The at least one scissor coupling member may be configured to at least one of: selectively open to physically couple the first membrane with the second membrane, and selectively close to physically decouple the first membrane with the second membrane; and selectively operate in a rigid open position to physically couple the first membrane with the second membrane, and in a loose open position to relatively decouple the first membrane with the second membrane.

The at least one adjustable coupling may comprise at least two adjustable couplings configured to be controlled separately.

The at least one adjustable coupling may comprise an adjustable coupling with a coupling gain greater than one.

According to a second aspect of the application there is provided a method comprising: providing in an acoustic transducer at least two membranes, wherein at least one of the first and second membranes are suitable for providing an acoustic wave response value; and adjustably coupling oscillations between a first membrane and a second membrane of the at least two membranes.

Adjustable coupling may comprise at least one of: adjustable mechanical coupling; adjustable hydraulic coupling; and adjustable pneumatic coupling.

The method may further comprise: determining at least one characteristic of the oscillation of at least one of the first membrane and second membrane; and controlling the coupling dependent on the characteristic.

The characteristic of the oscillation may comprise at least one of: maximum amplitude of the oscillation; energy of the oscillation; and frequency distribution of the oscillation.

Adjustably coupling may comprise decoupling the first membrane and a second membrane of the at least two membranes.

The method may further comprise directly receiving at the second membrane a sound pressure wave from an exterior of the acoustic transducer.

Adjustably coupling may comprise: defining a volume of air between the first membrane and the second membrane; and adjustably closing or opening the defined volume of air between the first membrane and the second membrane.

Defining a volume of air between the first membrane and the second membrane may comprise locating the first and the second membrane within a support structure wherein the support structure is provided with an adjustable valve.

Adjustably coupling may comprise: defining a volume of liquid between the first membrane and the second membrane; and adjustably closing or opening the defined volume of liquid between the first membrane and the second membrane.

Adjustably coupling may comprise providing at least two adjustable couplings configured to be controlled separately.

Adjustably coupling may comprise adjustably coupling with a coupling gain greater than one.

An integrated circuit may comprise the acoustic transducer as discussed herein.

According to a third aspect there is provided an acoustic transducer comprising: at least two oscillation detecting means for detecting acoustic wave oscillations; and at least one adjustable coupling means for adjustably coupling oscillations between a first and a second of the at least two oscillation detecting means.

The at least one adjustable coupling means may comprise at least one of: at least one adjustable mechanical coupling; at least one adjustable hydraulic coupling; and at least one adjustable pneumatic coupling.

The acoustic transducer may further comprise: means for determining at least one characteristic of the oscillation of the at least one of the first and second of the at least two oscillation detecting means; and means for controlling the at least one adjustable coupling means dependent on the characteristic.

The characteristic of the oscillation may comprise at least one of: maximum amplitude of the oscillation; energy of the oscillation; and frequency distribution of the oscillation.

The adjustable coupling means may be configured to decouple oscillations between the first and the second of the at least two oscillation detecting means.

The second of the at least two oscillation detecting means may be configured to directly receive a sound pressure wave from an exterior of the acoustic transducer.

The adjustable coupling means may comprise: a volume of air between the first and the second of the at least two oscillation detecting means; and an adjustable valve configured to seal, partially seal or open the volume of air.

The acoustic transducer may further comprise means for supporting the acoustic transducer configured to locate the first and the second of the at least two oscillation detecting means and define the volume of air between the first and the second of the at least two oscillation detecting means, wherein the adjustable valve may be defined by the means for supporting the acoustic transducer and one of the first and the second of the at least two oscillation detecting means.

The adjustable coupling means may comprise: a volume of liquid between the first and the second of the at least two oscillation detecting means; and an adjustable valve configured to seal, partially seal or open the volume of liquid.

The adjustable coupling means may comprise at least one rotational coupling rod configured to selectively rotate to a first position to physically couple the first and the second of the at least two oscillation detecting means, and to a second position to physically decouple the first and the second of the at least two oscillation detecting means.

The adjustable coupling means may comprise at least one scissor coupling member.

The at least one scissor coupling member may be configured to perform at least one of: selectively open to physically couple the first and the second of the at least two oscillation detecting means, and selectively close to physically decouple the first and the second of the at least two oscillation detecting means; and selectively operate in a rigid open position to physically couple the first and the second of the at least two oscillation detecting means, and in a loose open position to relatively decouple the first and the second of the at least two oscillation detecting means.

The at least one adjustable coupling means may comprise at least two adjustable couplings means configured to be controlled separately.

The at least one adjustable coupling means may comprise an adjustable coupling with a coupling gain greater than one.

### SUMMARY OF FIGURES

For better understanding of the present invention, reference will now be made by way of example to the accompanying drawings in which:

FIG. 1 shows schematically an electronic device employing embodiments of the invention;

FIG. 2a shows schematically the electronic device in further detail;

FIG. 2b shows schematically some functional components of the electronic device according to some embodiments;

FIG. 3 shows schematically a floating over rigid membrane example topology for the transducer according to some embodiments;

FIG. 4 shows schematically a rigid over floating membrane example topology for the transducer according to some embodiments;

FIG. 5 shows schematically a floating membrane example topology for the transducer according to some embodiments;

FIG. 6 shows schematically a controllable leak membrane example topology for the transducer according to some embodiments;

FIGS. 6a and 6b show schematically details of the controllable leak as shown in FIG. 6;

FIG. 7 shows schematically a double back plate membrane example topology for the transducer according to some embodiments;

FIG. 8 shows schematically a coupling member suitable for coupling the membranes according to some embodiments;

FIG. 9 shows schematically a rotatable coupling member suitable for coupling the membranes according to some embodiments;

FIG. 10 shows schematically a scissor action coupling member suitable for coupling the membranes according to some embodiments;

FIG. 11 shows a flow diagram showing the operation of the transducer; and

FIGS. 12 to 14 show further mechanical membrane coupling arrangement embodiments.

### DESCRIPTION OF EXAMPLE EMBODIMENTS

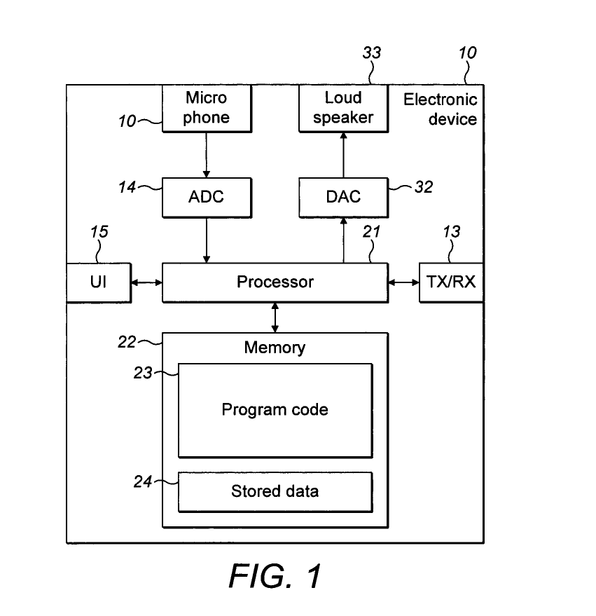

The following describes in further detail suitable apparatus and possible mechanisms for the provision of transducers having changeable acoustic properties. In this regard reference is first made to FIG. 1 which shows a schematic block diagram of an exemplary apparatus or electronic device 10, which may incorporate transducers having changeable acoustic properties according to some embodiments. In the following examples and embodiments the transducer receives or generates an analogue signal which is processed by an associated analogue to digital converter, however it would be understood that in some embodiments the microphone/speaker is an integrated transducer generating digital or receiving digital signals directly. Furthermore in some embodiments the transducer mechanical filter is a pure analogue design, in other words processing is performed in the analogue domain with respect to the mechanical acoustic filter.

The electronic device 10 may for example be a mobile terminal or user equipment of a wireless communication system.

The electronic device 10 comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (TX/RX) 13, to a user interface (UI) 15 and to a memory 22.

The processor 21 may be configured to execute various program codes. The implemented program codes may comprise transducer control routines. The implemented program codes 23 may further comprise an audio encoding/decoding code. The implemented program codes 23 may be stored for example in the memory 22 for retrieval by the processor 21 whenever needed. The memory 22 may further provide a section 24 for storing data.

The user interface 15 may enable a user to input commands to the electronic device 10, for example via a keypad, and/or to obtain information from the electronic device 10, for example via a display. The transceiver 13 enables a communication with other electronic devices, for example via a wireless communication network. The transceiver 13 may in some embodiments of the invention be configured to communicate to other electronic devices by a wired connection.

It is to be understood again that the structure of the electronic device 10 could be supplemented and varied in many ways.

A user of the electronic device 10 may use the microphone 11 for inputting speech, or other sound signal, that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 may convert the input analogue audio signal into a digital audio signal and provides the digital audio signal to the processor 21.

The processor 21 may then process the digital audio signal in the same way as described with reference to the description hereafter.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 may also receive a bit stream with correspondingly encoded data from another electronic device via the transceiver 13. In this case, the processor 21 may execute the decoding program code stored in the memory 22. The processor 21 may therefore decode the received data, and provide the decoded data to the digital-to-analogue converter 32. The digital-to-analogue converter 32 may convert the digital decoded data into analogue audio data and outputs the analogue signal to the loudspeakers 33. Execution of the decoding program code could be triggered as well by an application that has been called by the user via the user interface 15.

In some embodiments the loudspeakers 33 may be supplemented with or replaced by a headphone set which may communicate to the electronic device 10 or apparatus wirelessly, for example by a Bluetooth profile to communicate via the transceiver 13, or using a conventional wired connection.

In some embodiments the hardware integration of the transducers, such as the microphone 11 or the speaker 33, is in the form of a micro electromechanical system (MEMS) integrated circuit implementation. Although the description herein further details the operation of embodiments of the application with respect to microphone transducers it would be appreciated that the similar apparatus and methods can be employed to speaker operations and/or combined microphone speakers.

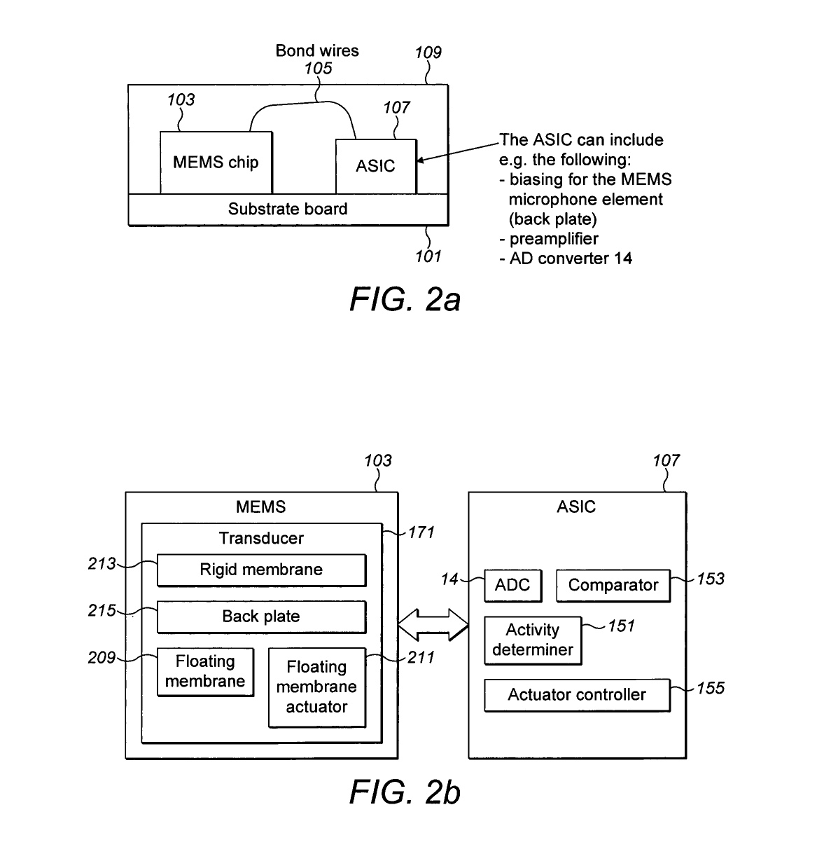

With respect to FIG. 2a an example of the hardware integration of the transducer is shown within the electronic device or apparatus 10 according to some embodiments. In some embodiments the transducer and in particular the microphone 11 can be implemented as a micro-electromechanical system (MEMS) implemented on an integrated circuit or chip. Although the apparatus and methods described herein relate to a MEMS microphone transducer, any transducer employing a membrane (or surface, or diaphragm) for generating or detecting acoustic waves can implement similar embodiments. For example any suitable condenser microphone can employ membrane combinations as described herein.

The MEMS chip 103 can in some embodiments be mounted physically on the substrate board 101 within the casing 109 of the electronic device or apparatus 10. The MEMS chip 103 furthermore in some embodiments can be located neighbouring an acoustic portal provided within the casing of the electronic device or apparatus. The acoustic portal is configured to allow acoustic signals to pass ‘through’ the casing of the apparatus between the transducer and the environment the apparatus is operating in. In some embodiments the acoustic portal can be at least one hole in the casing. The hole can furthermore be covered in some embodiments by a dust or water resistant or proof screen to prevent foreign bodies from entering the device and damaging any components within the apparatus. The MEMS chip 103 can in some embodiments be mechanically and/or electrically fixed on the substrate 101 to prevent movement of the MEMS chip 103 and/or locate the MEMS chip 103 relative to the acoustic portal in the apparatus. In some embodiments the MEMS chip 103 can be mechanically located (mounted) on the substrate board 101 in such a manner that audio waves can pass through the acoustic portal (and in some embodiments sound channels between the casing and the MEMS chip 103) in the casing 109 to the MEMS chip 103. In some embodiments the substrate board 101 can itself comprise a sound channel through which the acoustic waves pass through.

With respect to FIG. 2b, a schematic view of the MEMS chip 103 is shown.

In some embodiments the MEMS chip comprises a transducer 171, which is configured in the description herein to be to operate as the microphone 11. In some embodiments the MEMS chip 103 can comprise further transducers configured to operate as further microphones and/or configured to operate as a loudspeaker 33. However for clarity the following description describes embodiments of the application having a single transducer/single microphone implementation.

In some embodiments the transducer 171 comprises a (first) main or rigid membrane 213, a back plate 215, a (second) floating membrane 209, and a floating membrane actuator 211. In other words in some embodiments the transducer can comprise at least two oscillation detecting means for detecting acoustic wave oscillations.

The main or rigid membrane 203 can be formed from any suitable material and is configured to move in response to acoustic signals or waves applying a force against the membrane. In some embodiments the rigid membrane 203 can be configured to be mechanically coupled to an actuator such as a moving magnet or moving coil to generate an electrical signal in response to the movement of the rigid membrane 203. The rigid membrane 203 refers to the membrane which is ‘fixed’ at at least part of the periphery of the rigid membrane 203 as compared to the floating membrane 209 which can be configured to be moved and/or translated with respect to the rigid membrane 203. In some embodiments the main membrane 203 is not physically attached to the support structure and can therefore ‘float’ with respect to the supporting structure.

In some other embodiments the rigid membrane 203 is electrostatically or electrically charged and causes a change in potential as it moves. For example in some embodiments the rigid membrane 203 is configured to be a mobile capacitor plate relative to a fixed capacitor plate provided by the back plate 205, electrical couplings to each of the two capacitor plates when charged will produce a varying potential as the membrane moves relative to the back plate.

The floating membrane 209 can be formed from any suitable material and is configured to move, resonate, in response to acoustic signals or waves applying a force against the membrane. Furthermore as discussed herein the floating membrane 209 can be moved, translationally, by the floating membrane actuator 211.

The floating membrane actuator 211 is configured in some embodiments to actuate or move the floating membrane 209. Thus in some embodiments the action of the floating membrane actuator and therefore the motion of the floating membrane 211 can be configured to form a mechanical acoustic filter (or electrically controllable mechanical acoustic filter means for changing the acoustic properties of a transducer).

The back plate 205 is a material layer which can in some embodiments underlie the microphone membrane 203 and can assist to define a ‘back volume’ or acoustic chamber between the membrane 203, the back plate 205, and rearwards (in other words in the opposite direction to the acoustic wave input). The relative position and form of the back plate 205 can in some embodiments be designed as a compromise between producing a good noise performance and overall size of the transducer as it would be understood that a smaller back volume is preferable to produce a smaller MEMS chip or transducer but producing a less acceptable noise spectrum of the noise floor output by the transducer. In some embodiments the back plate 205 comprises at least one back plate hole. The back plate hole can in some embodiments be further used to tune the response of the transducer and permit the membrane to move more freely. In some other embodiments the back plate hole can be located or formed in any support structure which also forms or defines the acoustic chamber. In some embodiments the back plate hole can be covered or at least partially covered to prevent or reduce foreign bodies entering the acoustic chamber.

Embodiments of the application are based on the concept of the two (or more) membranes (the first and the second membranes) within the microphone which are adjustably coupled. The membranes can be adjustably coupled according to some embodiments using an adjustable acoustic/mechanical coupling. The second membrane thus located adjacent the main membrane is coupled in such a way that it is possible to control how the sound/acoustic pressure waves move the membrane being used to capture the sound/acoustic pressure wave and therefore adjust the frequency response and output signal level of the microphone.

Thus the transducer can be considered to comprise at least one adjustable coupling means for adjustably coupling oscillations between a first and a second of the at least two oscillation detecting means (or membranes). The coupling between the membranes can in some embodiments be mechanical or use adjustable mechanical means to conduct movement from one membrane to another. In some other embodiments the adjustable coupling means between the membranes can be pneumatic coupling means in other words the volume of air between the two membranes. In some embodiments the membranes can be coupled by an adjustable hydraulic coupling means such that the membrane under the effect of the sound pressure wave is configured to pressurise a liquid which unable to compress under the pressure can pass the pressure change onto a further membrane. In such embodiments leak conduits or windows can be configured to be opened or closed allowing the hydraulic fluid to escape from the volume between the membranes and thus adjustably couple or decouple the two membranes. In some embodiments the further membrane and fluid can further dampen the motion of the membrane in the direct path of the sound pressure wave.

The adjustable coupling means can thus in some embodiments comprise: a volume of air between the first and the second of the at least two oscillation detecting means; and an adjustable valve configured to seal, partially seal or open the volume of air. Furthermore in such embodiments the acoustic transducer can comprise means for supporting the acoustic transducer configured to locate the first and the second of the at least two oscillation detecting means and define the volume of air between the first and the second of the at least two oscillation detecting means, wherein the adjustable valve may be defined by the means for supporting the acoustic transducer and one of the first and the second of the at least two oscillation detecting means. Furthermore as discussed herein the adjustable coupling means can comprise: a volume of liquid between the first and the second of the at least two oscillation detecting means; and an adjustable valve configured to seal, partially seal or open the volume of liquid.

In some embodiments the coupling means can be a combination of any suitable coupling means. For example in some embodiments the coupling means can comprise a combination of pneumatic and mechanical coupling means. In some other embodiments the combination coupling means comprises a hydraulic and mechanical coupling.

In some embodiments the coupling means produce an applied pressure transfer ratio greater than unity. For example a mechanical, pneumatic or hydraulic gain can be achieved by the membrane directly experiencing the sound pressure wave having a surface area greater than the surface area of the coupled membrane. In some other embodiments a mechanical gain can be used in coupling the membranes. For example the pressure level gain can be generated by use of a lever, where the lever is coupled at a point a first distance from the pivot is coupled to the membrane in direct contact with the sound pressure wave and the lever is coupled at a point a second distance from the pivot to the other membrane. Where the second distance is less than the first distance the applied pressure can be increased from the membrane to the other membrane. Similarly where the second distance is greater than the first the amplitude of motion is increased but the pressure is decreased.

Therefore in some embodiments the at least one adjustable coupling means can comprise at least two adjustable couplings means configured to be controlled separately. Furthermore in some embodiments the at least one adjustable coupling means can comprise an adjustable coupling with a coupling gain greater than one

As will be described herein, in some embodiments an application specific integrated circuit (ASIC) located within the MEMS microphone can provide biasing for the “main membrane” and furthermore be used to control the adjustable coupling means operating between the membranes. In some embodiments the application specific integrated circuit (ASIC) as described herein can further receive an input from at least one of the membranes and from such a signal control the adjustable coupling means and therefore control the degree of coupling between the membranes.

In some embodiments employing a pneumatic coupling means, the degree of coupling can be controlled by one of the membranes configured with an adjustable bypass or “leak” means such as a hole or acoustic conduit located adjacent to the membrane. These holes can thus act as a compressor attenuating the highest sound pressure wave pressure changes. In some embodiments these adjustable holes can be activated especially with respect to low frequency sound pressure waves. In some embodiments these holes or conduits can further be adjustable and controlled in such a manner that the degree of bypass or leaking and thus the compression can be controlled electronically.

In some embodiments the coupling means can be configured to adjust the degree of coupling between the membranes when the outer most membrane is compressed by large amplitude sound pressure wave levels with the assistance of a supporting structure for the membrane enabling the membrane to be resilient. In some embodiments the degree of coupling between the membranes can be biased by using a mechanical means such as resilient means, a spring, or spring-like mechanical structure to provide progressive compliance to the membrane so that the membrane rests at an initial position under no sound pressure wave level but is configured such that the larger the amplitude of deviation of the membrane due to the increasing sound pressure wave level, the tighter the spring/resilient member becomes and thus the force required to move the membrane increases. It would be understood that such embodiments would require the resilient member or spring to be configured in order to minimise the distortion created to be an acceptable level such that the resultant audio signal does not sound unpleasant. The resilient member or spring can furthermore be employed in embodiments which can use only a single membrane. In other words the adjustable coupling and second membrane are replaced by the mechanical damping.

In such embodiments the adjustable coupling means can be configured to decouple oscillations between the first and the second of the at least two oscillation detecting means.

In some embodiments the coupling means can be controlled electrically in a manner that the sensitivity of the microphone decreases the larger the amplitude deviation of the membrane. For example in some embodiments by adding a back plate to the additional or second membrane to generate an output signal in addition to the main membrane output signal, the second output signal can be used to control the adjustable coupling means and/or process the output signal of the main membrane in a suitable manner.

In some embodiments the actuator can comprise means for determining at least one characteristic of the oscillation of the at least one of the first and second of the at least two oscillation detecting means; and means for controlling the at least one adjustable coupling means dependent on the characteristic. The characteristic of the oscillation can comprise in some embodiments at least one of: maximum amplitude of the oscillation; energy of the oscillation; and frequency distribution of the oscillation.

For example the output of the main membrane can be attenuated (compressed) when the amplitude of the additional membrane reaches a determined threshold amplitude value.

The properties of the second membrane, for example sensitivity frequency response leaks, and possible compression can be designed carefully to enable optimal performance of the electrical signal processing.

It would be understood that although the following examples describe the use of a single additional or second membrane that any number of additional membranes can be introduced with adjustable coupling means located between pairs of membranes.

In some embodiments this can permit the operation of the microphone in extreme sound pressure wave level environments as the coupling factor permits significantly large degrees of decoupling to be achieved yet permit the main membrane to be as sensitive as required to be for low sound pressure wave level environments. Furthermore it would be understood that where the microphone is a directional microphone with multiple sound ports for example in some embodiments where there are sound ports are on either side of the membrane, there can be “second” membranes either side of the main membrane.

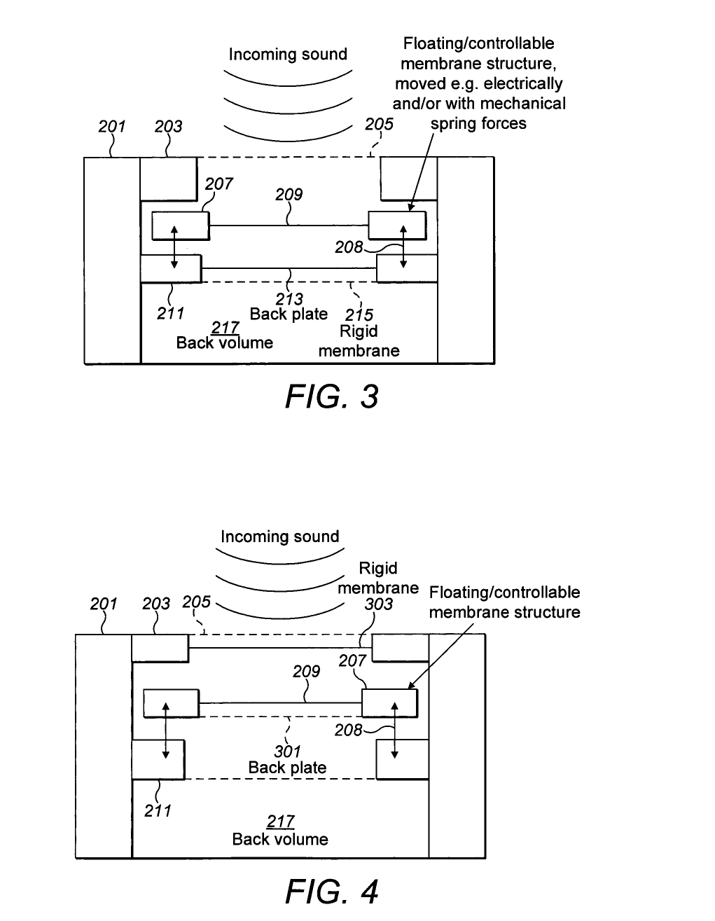

The topology of the transducer can be further described with respect to the examples shown in FIGS. 3 to 10. In the following embodiments directional terms are with reference to the acoustic wave source direction, in other words “upwards” and “over” refers to the direction from which the acoustic wave is received. However in some other embodiments the directionality is to assist the understanding or the local orientation of components only and not to provide a global or external orientation indication.

With respect to FIG. 3, a first example of the coupled membrane concept is shown wherein a floating or second membrane is located over a main or rigid membrane. The example topology of a suitable microelectromechanical system (MEMS) microphone structure for implementation in some embodiments of the application is shown in FIG. 3 as a cross-sectional elevation view. The MEMS 103 microphone comprises in some embodiments a support frame 201 configured to support elements of the microphone such as a cover support 203, a cover 205, a floating membrane actuator 211, a rigid membrane 213 and a back plate 215.

The support frame 201 can in some embodiments be part of the external structure of the MEMS chip 103 into or through which a cavity defines the volume within which the membranes and back plates are located. In some embodiments the cavity can be maintained or etched from a block form or can be formed by assembling the support structure. The support frame 201 in some embodiments can have any suitable shaped structure, for example the support frame can have a hexagonal, octagonal or circular extruded form. Within the support frame 201 the MEMS microphone 103 can comprise a cover support 203 over or between which is located a cover 205 or dust net configured to mechanically protect the MEMS microphone 103 component from physical damage, and furthermore protect the MEMS microphone 103 from contamination from foreign objects such as from particulate (metallic or otherwise), or liquid damage. The cover support 203 can thus in some embodiments suspend a cover 205, with perforations suitable for enabling the acoustic waves to pass through the cover region from the exterior of the device into the MEMS acoustic cavity region. In other words the cover is acoustically transparent or opaque.

In some embodiments the cover support 203 is integrally part of the support structure 201 or the “upper” surface of the MEMS chip.

Furthermore the MEMS microphone 103 in some embodiments comprises a rigid membrane 213. In some embodiments the rigid membrane 213 is supported by a rigid membrane support. The rigid membrane support can in some embodiments further be a floating (or controllable) membrane actuator 211 which furthermore controls the floating or controllable membrane structure comprising a floating membrane support 207 and a floating membrane 209. The floating membrane support 207 can support the floating membrane such that the floating membrane is supported by the floating membrane support 207. In some embodiments the coupling between the rigid membrane 213 and floating membrane 209 can be characterised by a coupling element 208. In the embodiment shown in FIG. 3 the coupling element 208 is the column/volume of air between the rigid and floating membrane. Furthermore the actuator 211 can be shown to control the coupling element 208. In some embodiments the pneumatic coupling/air coupling can be controlled by the actuator 211 moving the floating membrane 209 with respect to the surrounding components.

In some embodiments the floating membrane structure can be designed to be located within the actuator support structure such that the floating membrane structure has a first shape which generally matches the shape of the actuator support structure. For example the floating membrane structure could be octagonal and the actuator support structure is a slightly larger octagonal structure permitting the floating membrane structure to move ‘up’ and ‘down’ but not rotationally within the actuator support structure. Furthermore in some embodiments the actuator support structure could have grooves/slots or tabs which correspond to opposite features in the floating membrane structure.

For example in some embodiments the floating membrane 209 and floating membrane support 207 can be attracted to (or repelled from) the floating membrane actuator by electrostatic or electrical field forces. The electrical field or electrostatic forces produced in some embodiments can produce suitable push/pull forces on the floating membrane locating the floating membrane actuator 211 (and thus the rigid membrane) with respect to the floating membrane support 207 and floating membrane 209. The shape of the floating membrane 209 and the surrounding floating membrane support structure 207 can be designed such that the location of and air gaps surrounding the floating support structure 207 and floating membrane 209 enable a suitable variation in the pneumatic coupling between the two membranes. In other words the membrane coupling can then be controlled by changing the forces applied to the floating membrane structure.

For example the floating membrane actuator 211 can be configured to generate an electrical field by applying a suitable potential which can interact with a electrical field/electrostatic field/magnetic field generated by the floating membrane support 207 to produce a repulsive force overcoming the weight of the floating membrane structure 207/209 allowing the structure 207/209 to “hover” above the rigid membrane. In some embodiments the floating membrane support 207 can thus be configured with a permanent magnet structure which reacts to the electrical field generated by the floating membrane actuator 211 to float or hover a height over the rigid membrane 213, the height defined by the potential of the electrical field. Furthermore as shown in FIG. 3, the floating membrane can be configured such that the floating membrane support structure 207 width is smaller than the MEMS support structure 201 volume cross-section forming air leaks or bypass regions which prevent a seal or pressure coupling between the floating membrane and rigid membrane. Thus incoming acoustic pressure waves strike the floating membrane which vibrates creating sound pressure waves in the air volume under the floating membrane. However the “leaks” or “bypass” regions surrounding the floating membrane structure enable some of the sound pressure waves to pass around the sides of the floating membrane structure 207/209 such that only some of the sound pressure waves reach the rigid membrane 213 which causes a deviation in the rigid membrane structure detectable by the MEMS microphone structure. The acoustic wave impinging on the rigid membrane surface therefore causes the rigid membrane surface to move relative to the back plate 215 enabling a deviation in a potential between the rigid membrane and back plate to be detected.

The location (or position) of the floating membrane structure 207/209 relative to the rigid membrane can thus control the amplitude and frequency response of the MEMS microphone.

For example in some embodiments the actuator can be configured to, at rest, locate the floating membrane structure such that it is at a height whereby the “upper” surface of the floating membrane support and the “lower” surface of the cover support form a substantially air tight seal, reducing the leak or bypass and enabling a better coupling between the membranes. However where the incoming sound pressure waves are substantial, the force of the incoming pressure waves on the floating membrane can push the floating membrane towards the rigid membrane opening the gap (leak or bypass) through which the pressure wave can escape and not reach the rigid membrane 213, in other words decoupling the floating membrane from the rigid membrane. In some embodiments the floating membrane actuator 211 can actively control the coupling and therefore the amount of incoming sound pressure wave reaching the rigid membrane 213, for example by decreasing the repulsion force on the floating membrane structure 207/209 such that it opens the bypass/leak volume of air between the floating and rigid membranes dependent on the detected sound pressure wave level reaching a determined threshold value.

With respect to FIG. 4 a further example air coupling structure is shown wherein the rigid membrane 303 is located directly behind (or underneath) the cover 205 rather than supported by the floating membrane actuator 211. Underneath (or behind) the rigid membrane/cover support is the floating membrane structure 207/209. Furthermore the back plate 301 in some embodiments is located directly behind (or underneath) the floating membrane structure 207/209. In such embodiments the floating membrane actuator can control the coupling between the rigid membrane 303 and the back plate 301 by controlling the force applied in the coupling 208 between the floating membrane actuator 211 coupled to the support structure 201 and the floating membrane structure 207/209. Thus in some embodiments when the incoming sound pressure wave level is too great the actuator can be configured to control the repulsion of the floating membrane structure 207/209 such that the floating/controllable membrane structure 207/209 can open a seal formed by the floating membrane structure 207/209 and either the upper surface of the actuator 211 (by reducing the force allowing the weight to pull the floating membrane structure away) or the lower surface of the cover support structure 203 (by increasing the force, overcoming the weight to push the floating membrane away), thus effectively dampening the frequency response of the microphone.

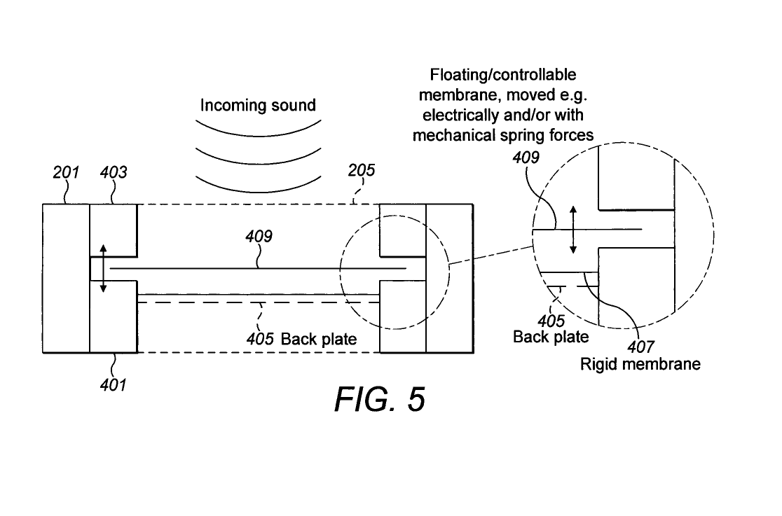

With respect to FIG. 5, a further example of some embodiments is shown wherein the floating membrane structure only comprises the floating membrane 409 and therefore is directly controllable via the floating membrane actuator 401 providing a force on the membrane and thus enabling the floating membrane to seal against the upper surface of the actuator 401 or the lower surface of the cover support 403 and without the floating membrane support structure.

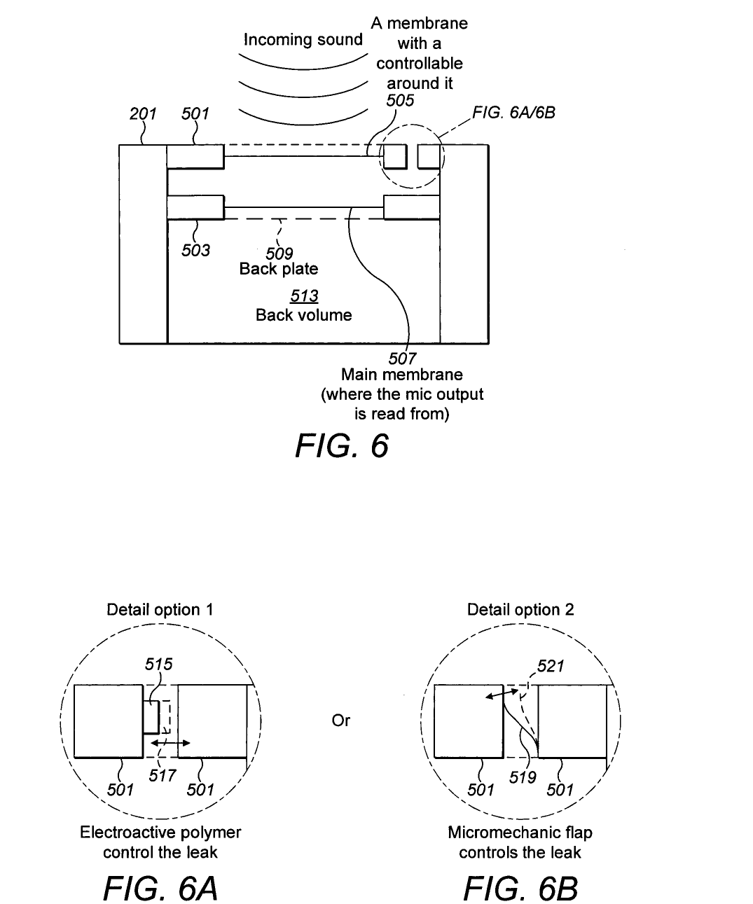

In some embodiments such as shown in FIG. 6, the coupling 208 can be controlled rather than by the use of a controllable leak surrounding one of the membranes. In such embodiments the second membrane can be fixed in location and not be mobile.

With respect to FIG. 6, an example of the controllable leak surrounding the second membrane is shown. In some embodiments the “controllable leak” or conduit can be located at any suitable position with a first opening within the volume of air defined between the main membrane and the second membrane and a second “exhaust” opening with a controllable “door” configured to open/close the leak. The support structure 201 in some embodiments as shown in FIG. 6 is coupled to a cover support 501 which supports a cover portion and underneath the cover portion a second membrane 505.

Furthermore the support structure 201 further is mechanically coupled to a main membrane support structure 503 located underneath the cover support structure and configured to support the main membrane 507 and back plate 509. The support structure 201, cover support 501, membrane 505, main membrane support 503 and main membrane substantially define a volume of air coupling the main and second membranes and which incoming sound pressure waves compress by striking the second membrane 505 compress the volume of air causing the main membrane 507 to vibrate.

The cover support 501 further can comprise the controllable leak or bypass element 511. The controllable leak or bypass 511 is configured to selectively allow air to leak (or bypass) from the defined volume and thus control the degree of sealing of the volume of air and the external environment and therefore the degree of coupling.

A detail example of the controllable leak is shown in FIG. 6a, where the conduit bypass element 511 is an electro-active polymer 515 with a controllable volume able to fill the conduit. The electro-active polymer thus occupies a volume or position in the conduit formed in the membrane support 501 providing a partial blockage of the conduit. However in some embodiments the application of an electrostatic or electrical potential causes the electro-active polymer to change in volume or dimension such that it can reduce the controllable leak or partially seal the conduit as shown in FIG. 6a by the dotted portion 617. Furthermore the electro-active polymer can in some embodiments completely close and thus seal the conduit and thus seal the volume of the air between the second membrane 505 and the main membrane 507. In other words the electro-active polymer can be controlled to provide a more complete coupling between the membranes 505 and 507 when the hole is sealed and also reduce the coupling effect (by the volume of air being able to escape between the second membrane 505 and the main membrane 507) when the hole is open.

Furthermore with respect to FIG. 6b, a further example control element or bypass element 511 configuration is shown where a micro-mechanical flap is employed to control the leak or bypass element. For example the conduit can be sealed thus producing a good coupling between membranes by locating the micromechanical flap in a first position, as shown in FIG. 6b 519 and sealing the “leak” element 511 and a second position 521 where the leak is partially open.

Although only a single conduit/bypass/hole is shown in the example shown in FIG. 6 it would be understood that in some embodiments more than one conduit can be employed, wherein each conduit can be similar to/or different from other conduits. Furthermore each conduit can in some embodiments be separately controlled permitting a tuning of the various degrees of sealing of the air volume to be permitted.

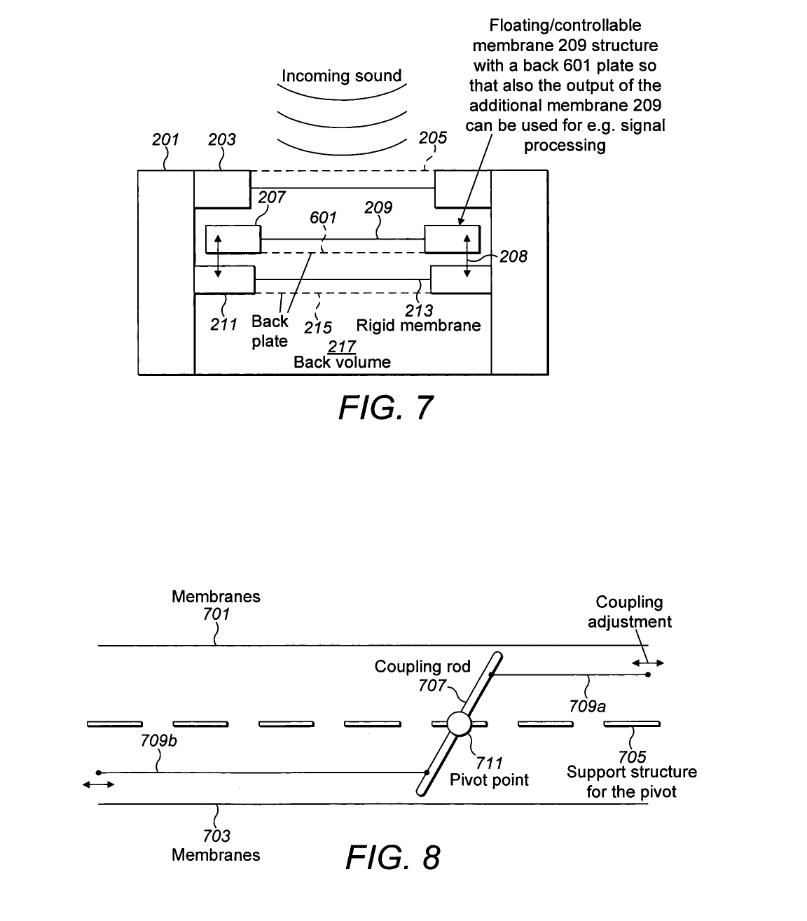

With respect to FIG. 7, a further embodiment of the application is shown wherein the floating or second membrane 209 can be associated with a second back plate 601 both located or supported by the floating membrane support 207 such that the floating membrane 209 with respect to the second back plate 601 can provide an output which can be used for determining the incoming sound pressure wave level and control the coupling between the membranes and/or signal processing of the main membrane output. The second membrane sound pressure level value output can thus be used as a secondary input other than, or additionally with, the rigid membrane 213 output for controlling the coupling between the membranes.

It would be understood that in some embodiments coupling between the membranes, such as provided by the “bypass conduit” control or positioning of the second membrane can be controlled by a combination of electrical forces and mechanical (spring) forces. For example in some embodiments the controllable or floating membrane can be biased such that it rests with the help of mechanical resilient member (or spring) against a rigid part of the MEMS structure (in other words the bypass can be biased to be closed or open, in other words to leak or not to leak). In such embodiments for example the electrical or electrostatic forces can be used to displace the floating membrane/floating membrane structure away from the bias position generated by the purely mechanical force.

It would be understood that the leak system physical dimensions can vary significantly dependent on the technology used and the membrane/back plate/volume can be optimised to achieve the performance required in terms of tuning and frequency response of the microphone and sound pressure level protection.

In some embodiments the coupling between the membranes can be mechanical rather than using the volume of air as the coupling mechanism.

With respect to FIG. 8 an example of a mechanical coupling between the second membrane 701 and the main membrane 703 is shown. In such embodiments the mechanical coupling comprises a coupling rod 707 configured when in position mechanically conduit movement of the second membrane 701 to the main membrane 703. The coupling rod 707 can be configured such that it has a length substantially the distance between the second membrane and the main membrane. Furthermore the coupling rod 707 is configured to pivot about a pivot point 711. The coupling rod 707 can be considered to be two separate coupling rod elements mounted at one end to the pivot point and separated by substantially 180°, in other words forming a substantially straight line. The pivot point 711 can in such embodiments be supported by a pivot support structure 705 which in some embodiments is an acoustically transparent structure located between the second membrane and the main membrane and mechanically fixed to the support structure 201 of the MEMS microphone. Furthermore the coupling rod 707 can have located and coupled to it off the pivot point, at least one coupling adjustment rod 709. The coupling adjustment rod 709a and 709b can be configured to rotate the coupling rod 707 about the pivot point such that the coupling rod is orientated such that the rod directly couples the motion of the second membrane 701 to the main membrane 703. In other words the coupling rod can in some embodiments be rotated in a plane substantially perpendicular to the membrane plane such that in one position the rod touches the membranes and rotates about the pivot point to be substantially perpendicular to the membranes and thus mechanically uncouple the second membrane 701 to the main membrane 703.

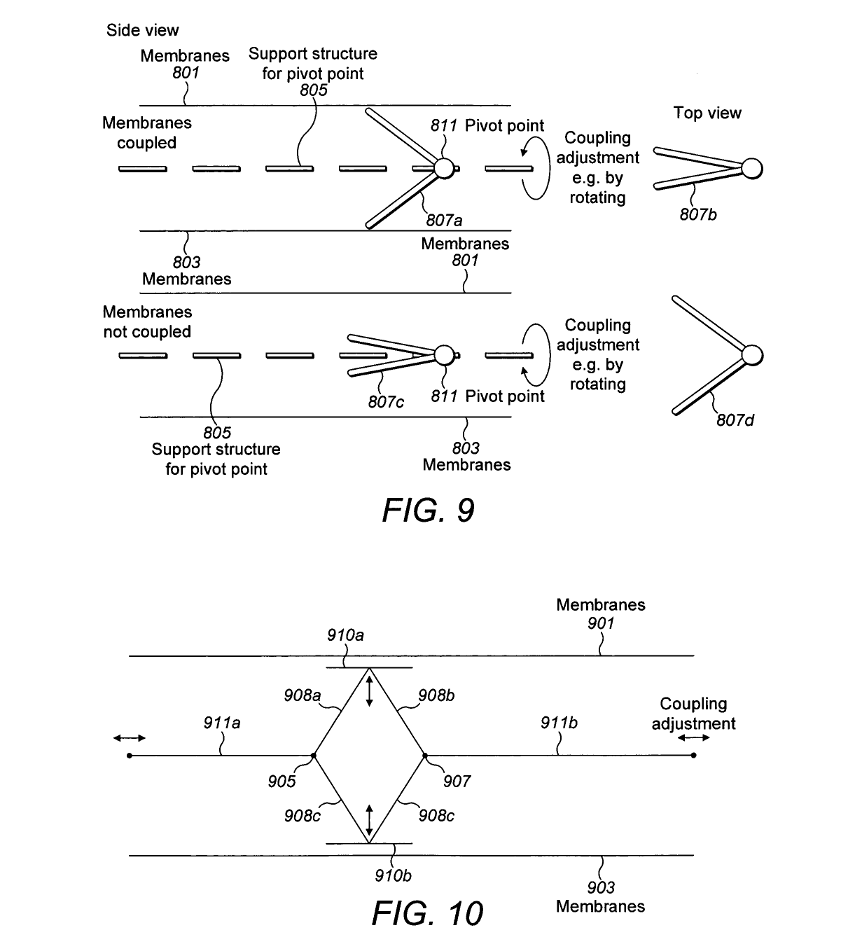

With respect to FIG. 9 a further mechanical coupling arrangement can be shown. The second membrane 801 and the main membrane 803 can be selectively coupled via a further coupling rod or rotational coupling member 807. The rotational coupling member 807 is a rigid rod structure whereby the rods are separated by an acute angle. Furthermore the rods can be rotated about a pivot point 811 such that the effective angular separation of the rods, with respect to the plane defined by the membranes and the pivot point, can be adjusted by the angular rotation of the rods about the pivot point 811. Furthermore the support structure 805 for the pivot point 811 can be located substantially halfway between the first membrane 801 and the main membrane 803.

The adjustable coupling means can thus in some embodiments comprise at least one rotational coupling rod configured to selectively rotate to a first position to physically couple the first and the second of the at least two oscillation detecting means, and to a second position to physically decouple the first and the second of the at least two oscillation detecting means.

With respect to FIG. 9 the side view and top view of the membranes in a coupled state and a non coupled state are shown.

Firstly with respect to the upper diagram the membranes can be coupled when the rotational mechanical coupling member 807 is rotated so that it has the greatest angular separation with respect to the membranes as shown in the side elevation (whilst having a narrower angular separation 807 as shown in the top view or plan elevation) whilst the membranes are not coupled when the mechanical rotational coupling member 807 is rotated such that the angle of separation is narrower between the two membranes.

Furthermore FIG. 10 shows a further mechanical coupling in the form of a scissor mechanical coupling. The scissor mechanical coupling comprises a first coupling element 910a configured to be suitable to couple with the second membrane 901 and a second membrane coupling element 910b configured to be suitable to couple a main membrane 903. Each of the membrane coupling elements 910 are configured to be mechanically attached to a pair of scissor rigid rods each configured to couple to the coupling element and pivoted an adjustment pivot. In other words rod 908a is configured to couple to the first coupling element 910a and the first adjustment pivot 905, the second rod 908b is configured to couple to the first coupling element 910a and the second adjustment pivot 907, the third rod 908c is configured to couple to the first adjustment pivot 905 and the second coupling element 910b and the fourth rod 908c is configured to couple to the second coupling element 910b and the second adjustment pivot 907.

The adjustable coupling means can thus in some embodiments comprise at least one scissor coupling member. The at least one scissor coupling member can in such embodiments be configured to perform at least one of: selectively open to physically couple the first and the second of the at least two oscillation detecting means, and selectively close to physically decouple the first and the second of the at least two oscillation detecting means; and selectively operate in a rigid open position to physically couple the first and the second of the at least two oscillation detecting means, and in a loose open position to relatively decouple the first and the second of the at least two oscillation detecting means.

A first and second coupling adjustment rod 911a and 911b are further configured to couple to the first and second adjustment pivots 905 and 907 respectively. Thus when the coupling adjustment rods 911a and 911b move horizontally apart, the scissor motion caused by the pivot point 905, 907 cause the coupling elements 910a and 910b to move away from the second and main membranes 901 and 903 respectively and thus mechanically decouple the two membranes. Whereas when the coupling adjustment rods move towards each other, the scissoring action causes the first and second coupling plates to contact the first and main membrane respectively, thus mechanically coupling the second membrane to the main membrane.

In some embodiments the coupling between the first and second membrane can furthermore be controlled by adjusting the tension of the scissor structure, in other words by altering the rigidity of the scissor structure which in turn is defined by the resilience of the coupling adjustment rods. For example in some embodiments the scissor structure is maintained by resilient forces on each coupling adjustment rod. These resilient forces can be adjusted or changed dependent on the main membrane amplitude such that the scissor structure can become slacker or tighter dependent the amplitude of the oscillations caused by the sound pressure wave forces on the second membrane.

The control of the coupling adjustment rods, rotational coupling, etc. can be configured to be electrically controlled.

With respect to FIG. 12 a further mechanical membrane coupling example is shown wherein the two membranes 1101 and 1111 are adjustably coupled by a pair of coupling rods 1103, 1109 which at one end are coupled to the membrane and to the other to a gearing system, which in some embodiments can be toothed cogs 1105, 1107. The gearing system can be configured such that there is a mechanical gain in the coupling system by the use of differing sized cog wheels (such as shown by cog wheel 1107 having a greater diameter than cog wheel 1105). In such embodiments a decoupling of the membranes can be achieved by actuating motion in either the coupling rods or cogs to disengage from the neighbouring cogs of coupling rods, such as shown in FIG. 12 by the arrow moving the coupling rod 1103 from the cog 1105 and therefore mechanically decoupling the two membranes.

With respect to FIG. 13 a further mechanical membrane coupling is shown wherein the membranes are coupled using a friction coupling between two coupling rods 1205, 1207 and a cam wheel 1209 with an eccentric profile to produce a mechanical advantage between the coupling rods 1205 and 1207. The coupling between the coupling rods 1205 and 1207 and cam wheel 1209 can be friction coupling which is supported by the resilient means (shown as springs) 1211 and 1213 biasing the coupling rods against the cam wheel 1209. In some embodiments the adjustable decoupling can be performed by removing or reducing the resilient means allowing the coupling rod to lose or reduce contact with the cam wheel 1209 and therefore the coupling rod slipping and not coupling the force on the coupling rod to the cam wheel.

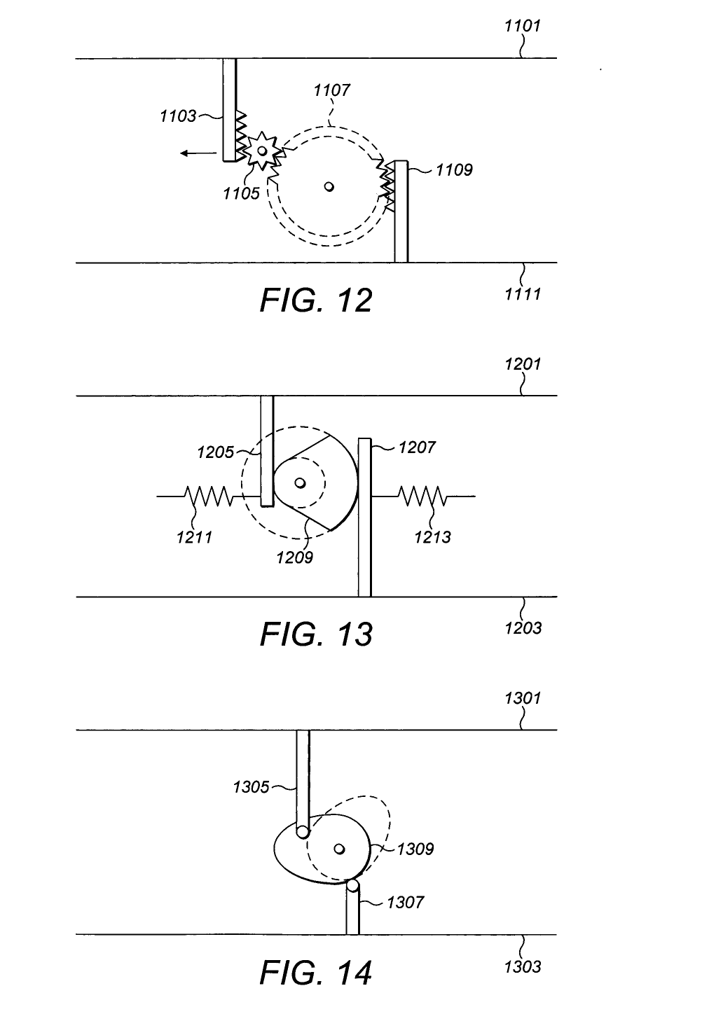

Furthermore in some embodiments, such as shown in FIG. 14 the mechanical membrane coupling can be performed by a cam following action. As shown in FIG. 14 a membrane 1301 is coupled by a coupling rod 1305 to an eccentric profile cam wheel 1309 where the coupling rod 1305 is configured to rotate the wheel as it moves up and down in response to the force on the membrane. The second coupling rod 1307 is coupled to the further membrane and furthermore follows the profile of the cam wheel 1309 as it rotates. In some embodiments the cam wheel profile can be configured to produce a non-linear coupling between the membrane 1301 and further membrane 1303 so that large amplitude motion on the coupling rod 1305 is reduced by the eccentric cam profile but small amplitude motion on the coupling rod is coupled directly to the further coupling rod.

In some embodiments the mechanical coupling means between the membranes can be configured with multiple coupling elements. Furthermore in some embodiments the multiple coupling elements can be each controlled individually or a group of coupling elements controlled separately from a further group of coupling elements. In such embodiments the adjustable coupling of each of the elements can be used to tune the amplitude response. For example in some embodiments the coupling elements located at the periphery of the membrane structure can be controlled separately from the coupling elements nearer the centre of the membrane structure in such a manner that a high sound pressure wave amplitude can cause the coupling elements nearer the centre of the membrane structure to decouple leaving only the peripheral coupling elements coupling the membranes. In such a manner it can be possible to have degrees of mechanical coupling between the membranes.

With respect to FIGS. 2a and 2b are shown apparatus for controlling the operation of the mechanical acoustic filter within the transducer. For example the apparatus shown in FIG. 2a comprises an application specific integrated circuit (ASIC) 107 located on the substrate board 101 with the MEMS chip 103 and coupled to the MEMS chip 103 by a bond wire 105. The ASIC 107 can in some embodiments be optional with the functionality of the ASIC 107 implemented by other elements such as for example a processor running programs to perform the same functionality, the programs being stored on a memory which can also be used to store data to be processed or processed. In some embodiments the ASIC 107 or at least some elements of the ASIC 107 as described herein can be implemented within the MEMS chip 103. For example in some embodiments the analogue-to-digital converter 14 can be implemented within the MEMS chip 103.

With respect to FIG. 2b the application specific integrated circuit (ASIC) 107 according to some embodiments of the application is shown in further detail. In such embodiments the ASIC 107 can comprise an analogue-to-digital converter (ADC) 14 which is configured to receive from the microphone (or transducer 171 operating as the microphone) and convert analogue electrical signals into a suitable digital format. In some embodiments the ASIC 107 can further comprise an equaliser. The equaliser can be configured with differing filter settings dependent on the activity of the blocking member and filter hole to assist tune the response of the membrane.

In some embodiments the ASIC 107 can comprise an activity determiner 151. The power determiner in some embodiments can be configured to receive the digital format signals from the ADC 14 and generate a measure of the microphone activity such as for example the power of the signal. In some other embodiments the activity measurement can be a frequency dependent power spectrum for the microphone signal over a determined window or time period. In such embodiments the ASIC 107 can comprise a time to frequency domain converter such as a fast fourier transform converter or discrete fourier transform converter or any suitable time to frequency domain converter. In some embodiment the ASIC 107 can comprise a filterbank prior to the activity determiner 151 and configured to determine the activity of the microphone output for frequency ranges.

In some embodiments the ASIC 107 can comprise a comparator 153 configured to compare the output of the activity determiner 151 against at least one determined threshold value. The comparator 153 can in some embodiments be a fixed one or be a dynamic comparator configured to be able to vary the threshold values dependent the condition of the MEMS microphone. For example in some embodiments the comparator 153 could vary the threshold values dependent on the age of the microphone, whether the microphone has been damaged or for any suitable reason.

In some embodiments the ASIC 107 can comprise an actuator controller 155. The actuator controller 155 can in some embodiments receive the output of the comparator 153 and generate a signal to power the actuator 211 within the MEMS microphone 103.

The ASIC 107 can in some embodiments comprise further elements of known microphone or audio processing systems such as a processing capability for biasing the MEMS microphone element (in other words generating the charge difference between the membrane and back plate) or a preamplifier (for receiving the analogue audio signal and amplifying the analogue audio signal so that the signal is output a suitable potential range).

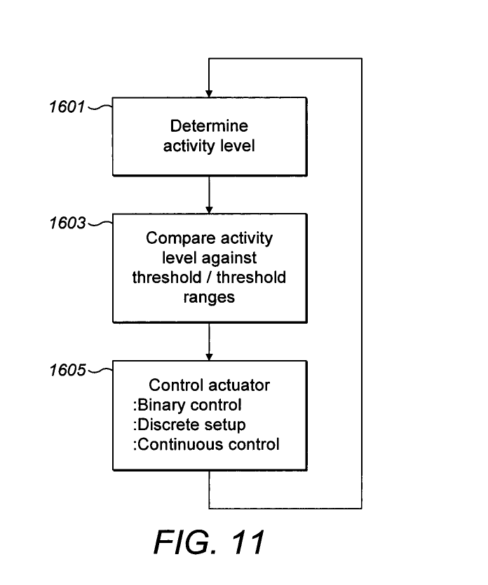

With respect to FIG. 11, an example control mechanism and method is shown for controlling the coupling.

As described herein the MEMS 103 microphone generates, for example in some embodiments by the motion of the membrane relative to the back plate a varying potential dependent on the acoustic waves applying a force to the floating membrane structure. However it would be understood that the apparatus and methods described with respect to these embodiments could be employed by any other embodiment coupling and decoupling membranes, e.g. controlling mechanical coupling actuation or bypass/hole actuation.

The ASIC 107 analogue-to-digital converter 14 can in some embodiments generate a digital representation of the microphone output from the main/second membrane. Furthermore the activity determiner 151 can in some embodiments generate a representation of the microphone activity. This in some embodiments can comprise the activity determiner 151 being configured to determine the power level for the microphone output by squaring the output values from the ADC 14. However the activity level can in some embodiments be frequency range dependent, in other words a value representing each frequency bin or range.

The determination of the activity value is shown in FIG. 11 by step 1601.

In some embodiments the activity level can be passed to a comparator 153. The comparator 153 can in some embodiments compare this activity level or value against at least one determined threshold value. The at least one threshold value can be stored in the ASIC 107 or in a memory. In some embodiments the threshold value can be modified when the transducer is in use, in other words the comparator 153 can “learn” when the transducer is about to saturate or produce a activity level or value indicative of a microphone saturation.

The comparator 153 can output the results of the comparison to the actuator controller 155.

The operation of determining whether the saturation volume level is greater than a threshold value is shown in FIG. 11 by step 1603.

The actuator controller 155 can then be configured to receive the result from the comparator 153 and output a suitable signal to control the coupling between membranes using the floating membrane actuator 211.

The actuator controller 155 can in some embodiments when the comparator 153 determines that the activity level is less than or equal to the determined threshold value send a signal to the floating membrane actuator 211 to move the floating membrane 209 to couple the membranes. For example in some embodiments the actuator controller 155 can be configured to pass a voltage level to the floating membrane actuator 211 such that the underside of the floating membrane structure is charged with a charge the same as the actuator to repel the structure and seal the bypass and therefore couple the two membranes by the air column between the two membranes (pneumatic coupling).

The operation of controlling of the actuator is shown in FIG. 11 by step 1605.

Following this control operation the method can in some embodiments pass back to the determination of the activity levels.

The actuator controller 155 can in these embodiments be also configured to when the comparator determines the activity level is greater than the threshold value send a signal to the floating membrane actuator 211 to move the floating membrane structure to open the “bypass” surrounding the structure. For example in some embodiments the actuator controller 211 can be configured to pass a voltage level to the actuator with a smaller or voltage charge to reduce the potential and allow the weight of the structure to move the floating membrane structure away from the lower surface of the cover support and open the bypass thus partially decoupling the two membranes.

The operation of controlling of the actuator is shown in FIG. 11 by step 1605.

Furthermore as described herein, this operation may be continuous and thus following the control operation the method passes back to a further determination of the activity of the microphone as shown in FIG. 11 by step 1601.

In some embodiments the actuation and deactivation of the floating membrane structure can be controlled or delayed. Thus in such embodiments an attack and/or release time can be implemented such that the actuation from couple to decouple is controlled by the determined attack time period and the deactivation from couple to decouple hole is controlled by the determined release time period. These attack and/or release time periods can be chosen in some embodiments to achieve a pleasant sounding transient period.

In some embodiments the blocking member can be configured to be naturally biased in either the coupled or uncoupled modes. In some embodiments the actuation can be implemented by means other than an actuator biased pad. For example in some embodiments the main membrane can be used as an actuator. In such embodiments the charge of the membrane itself can be sufficient to repel the floating membrane structure. In some embodiments the floating structure membrane can be configured such to prevent a permanent latch up, in other words the membrane cannot open the bypass. This can be achieved for example by having a membrane surface and/or other surface against which the membrane forms the seal having a rough profile and therefore does not allow the other surface to ‘stick’ to the membrane.

Furthermore in some embodiments permanent sticking or latch up of blocking members can be achieved by using an anti-stick coating on the blocking member and/or membrane.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-40. (canceled)

41. An acoustic transducer comprising:
at least two membranes; and
at least one adjustable coupling configured to adjustably couple oscillations between a first membrane and a second membrane of the at least two membranes.

42. The acoustic transducer as claimed in claim 41, wherein the at least one adjustable coupling comprises at least one of:
at least one adjustable mechanical coupling;
at least one adjustable hydraulic coupling; and
at least one adjustable pneumatic coupling.

43. The acoustic transducer as claimed in claim 41, further comprising a controller configured to determine at least one characteristic of the oscillation from the first membrane and control the at least one adjustable coupling dependent on the characteristic.

44. The acoustic transducer as claimed in claim 43, wherein the characteristic of the oscillation comprises at least one of:
maximum amplitude of the oscillation;
energy of the oscillation; and
frequency distribution of the oscillation.

45. The acoustic transducer as claimed in claim 41, wherein the adjustable coupling is configured to decouple oscillations between the first membrane and the second membrane of the at least two membranes.

46. The acoustic transducer as claimed in claim 41, wherein the second membrane is configured to receive a sound pressure wave from the exterior of the acoustic transducer.

47. The acoustic transducer as claimed in claim 41, wherein the at least one adjustable coupling is configured to adjustably couple oscillations between the first membrane and the second membrane of the at least two membranes comprises:
a volume of air between the first membrane and the second membrane; and
an adjustable valve configured to seal, partially seal or open the volume of air.

48. The acoustic transducer as claimed in claim 47, further comprising an acoustic transducer support structure configured to locate the first and the second membrane and define the volume of air between the first membrane and the second membrane, wherein the adjustable valve is defined by the acoustic transducer support structure and one of the first and second membranes.

49. The acoustic transducer as claimed in claim 41, wherein the at least one adjustable coupling configured to adjustably couple oscillations between the first membrane and the second membrane of the at least two membranes comprises at least one rotational coupling rod configured to selectively rotate to a first position to physically couple the first membrane to the second membrane, and to a second position to physically decouple the first membrane to the second membrane.

50. The acoustic transducer as claimed in claim 41, wherein the at least one adjustable coupling configured to adjustably couple oscillations between the first membrane and the second membrane of the at least two membranes comprises at least one scissor coupling member, wherein the at least one scissor coupling member is configured to at least one of:
selectively open to physically couple the first membrane with the second membrane, and selectively close to physically decouple the first membrane with the second membrane; and
selectively operate in a rigid open position to physically couple the first membrane with the second membrane, and in a loose open position to relatively decouple the first membrane with the second membrane.

51. The acoustic transducer as claimed in claim 41, wherein the at least one adjustable coupling configured to adjustably couple oscillations between the first membrane and the second membrane of the at least two membranes comprises at least two adjustable couplings configured to be controlled separately.

52. The acoustic transducer as claimed in claim 41, wherein the at least one adjustable coupling configured to adjustably couple oscillations between the first membrane and the second membrane of the at least two membranes comprises an adjustable coupling with a coupling gain greater than one.

53. A method comprising:
providing in an acoustic transducer at least two membranes, wherein at least one of the first and second membranes are suitable for providing an acoustic wave response value; and
adjustably coupling oscillations between a first membrane and a second membrane of the at least two membranes.

54. The method as claimed in claim 53, wherein adjustable coupling comprises at least one of:
adjustable mechanical coupling;
adjustable hydraulic coupling; and
adjustable pneumatic coupling.

55. The method as claimed in claim 53, further comprising:
determining at least one characteristic of the oscillation of at least one of the first membrane and second membrane; and
controlling the coupling dependent on the characteristic.

56. The method as claimed in claim 55, wherein the characteristic of the oscillation comprises at least one of:
maximum amplitude of the oscillation;
energy of the oscillation; and
frequency distribution of the oscillation.

57. The method as claimed in claim 53, wherein adjustably coupling comprises decoupling the first membrane and the second membrane of the at least two membranes.

58. The method as claimed in claim 53, wherein adjustably coupling comprises:
defining a volume of air between the first membrane and the second membrane; and
adjustably closing or opening the defined volume of air between the first membrane and the second membrane.

59. The method as claimed in claim 58, wherein defining a volume of air between the first membrane and the second membrane comprises locating the first and the second membrane within a support structure wherein the support structure is provided with an adjustable valve.

60. The method as claimed in claim 53, wherein adjustably coupling comprises one of:
providing at least two adjustable couplings configured to be controlled separately; and
adjustably coupling with a coupling gain greater than one.
